(19) United States
(12) Patent Application Publication
(10) Pub. No.: US 2019/0172275 A1
(43) Pub. Date: Jun. 6, 2019

(54) SYSTEM OF MEASURING RIDE CHARACTERISTICS OF A VEHICLE

(71) Applicant: William Elson, Des Moines, IA (US)

(72) Inventor: William Elson, Des Moines, IA (US)

(21) Appl. No.: 16/210,029

(22) Filed: Dec. 5, 2018

Related U.S. Application Data
(60) Provisional application No. 62/594,958, filed on Dec. 5, 2017.

(51) Int. Cl. G07C 5/08; G07C 5/00; B60W 30/02

(52) U.S. Cl. CPC G07C 5/0808; B60W 30/025; G07C 5/006; G07C 5/008

(57) ABSTRACT

A system for measuring ride characteristics of a vehicle, is presented that includes a module having a microprocessor, memory and instructions as well as a vibration sensor, a noise sensor, and a position sensor. The module is connected to a vehicle and when the vehicle is driven the module detects ride characteristics of the vehicle, such as vibration, direction, location, and noise levels. From this information the system establishes baseline ride characteristics, which is the optimal performance of the vehicle and compares the baseline ride characteristics to the actual or present ride characteristics. The system also establishes a threshold, which represents the worst acceptable ride characteristics. When the present ride characteristics exceed the threshold the system informs the user through a visual or audible alarm, a text or emailed message or through any other manner or means informing the user that it is time to repair or replace the vehicle.

### CROSS REFERENCE TO RELATED APPLICATIONS

This application claims benefit of U.S. Provisional Application No. 62/594,958 which was filed on Dec. 5, 2017, the entirety of which is incorporated herein fully by reference.

### FIELD OF THE INVENTION

This invention relates to vehicles. More specifically and without limitation this invention relates to a system of measuring ride characteristics of a vehicle.

### BACKGROUND OF THE INVENTION

It is known that over time the quality of a vehicle's ride deteriorates. However, the quality of a vehicle's ride is difficult to determine and it is often subjective. In addition, the quality of a vehicle's ride is based on a countless number of variables. Variables that affect the quality of a vehicle's ride include age of a vehicle, tire wear, wear of shock absorbers, wear of the suspension elements, road conditions, weather conditions, driving style, wheel bearings, and suspension settings, among countless other elements.

Complicating matters further is the fact that ride characteristics of a vehicle often change slowly over time. This slow change in ride characteristics makes it difficult to determine when repairs need to be made. In some cases this leads to unnecessary repairs being made earlier than they should which unnecessarily increases vehicle maintenance expense. In other cases this leads to vehicles going without needed repairs for far too long which can lower the user's satisfaction of the vehicle and can even pose a safety risk to the occupants of the vehicle.

Determining when to take corrective actions and when not to take corrective actions, as it pertains to the ride characteristics of a vehicle, requires understanding what the optimal or desired ride characteristics of a vehicle are and then understanding when these ride characteristics have changed in a manner beyond what is acceptable. However, there is no method, system or manner available on the market today that tracks a vehicle's ride characteristics and establishes a baseline of ride characteristic for that vehicle. Since there is no system available to determine the baseline of a vehicle's ride characteristics, there is no system, method or manner available to determine when the ride characteristics have changed dramatically enough to justify taking corrective action, such as implementing repairs, replacing a vehicle or the like.

Thus, it is a primary object of the disclosure to provide a system and method of measuring ride characteristics that improves upon the state of the art.

Another object of the disclosure is to provide a system and method of measuring ride characteristics that provides a baseline or optimal level of ride characteristics.

Yet another object of the disclosure is to provide a system and method of measuring ride characteristics that provides an objective measure of ride characteristics.

Another object of the disclosure is to provide a system and method of measuring ride characteristics that informs a user when ride characteristics of a vehicle have deteriorated to a point where repairs or changes are needed.

Yet another object of the disclosure is to provide a system and method of measuring ride characteristics that informs a user when ride characteristics of a vehicle are still within an acceptable range and as such repairs or changes are not needed.

Another object of the disclosure is to provide a system and method of measuring ride characteristics that provides statistical information regarding the ride characteristics of a vehicle.

Yet another object of the disclosure is to provide a system and method of measuring ride characteristics that provides graphical information regarding the ride characteristics of a vehicle.

Another object of the disclosure is to provide a system and method of measuring ride characteristics that is relatively inexpensive.

Yet another object of the disclosure is to provide a system and method of measuring ride characteristics that is easy to use.

Another object of the disclosure is to provide a system and method of measuring ride characteristics that improves safety.

Yet another object of the disclosure is to provide a system and method of measuring ride characteristics that detects subtle changes in a vehicle's ride characteristics over time.

Another object of the disclosure is to provide a system and method of measuring ride characteristics that can be used with practically any vehicle.

Yet another object of the disclosure is to provide a system and method of measuring ride characteristics that detects vibration.

Another object of the disclosure is to provide a system and method of measuring ride characteristics that detects noise levels.

Yet another object of the disclosure is to provide a system and method of measuring ride characteristics that detects body roll.

Another object of the disclosure is to provide a system and method of measuring ride characteristics that provides a ride score.

Yet another object of the disclosure is to provide a system and method of measuring ride characteristics that can inform a user what changes or repairs are needed, such as tire changes, wheel bearing changes, shock absorber changes, or the like.

Another object of the disclosure is to provide a system and method of measuring ride characteristics that provides a vertical baseline and a horizontal baseline.

Yet another object of the disclosure is to provide a system and method of measuring ride characteristics that is robust.

Another object of the disclosure is to provide a system and method of measuring ride characteristics that utilizes existing technology.

Yet another object of the disclosure is to provide a system and method of measuring ride characteristics that saves money.

Another object of the disclosure is to provide a system and method of measuring ride characteristics that eliminates waste.

Yet another object of the disclosure is to provide a system and method of measuring ride characteristics that improves user satisfaction.

Another object of the disclosure is to provide a system and method of measuring ride characteristics that is easy to implement.

Yet another object of the disclosure is to provide a system and method of measuring ride characteristics that is easy to install.

Another object of the disclosure is to provide a system and method of measuring ride characteristics that provides value, utility and novelty.

Yet another object of the disclosure is to provide a system and method of measuring ride characteristics that can be used in multiple vehicles by moving the system from vehicle to vehicle.

Another object of the disclosure is to provide a system and method of measuring ride characteristics that automatically determines what vehicle the system is riding in through wireless connection to the vehicle so as to accumulate ride data across multiple vehicles.

These and other objects, features, or advantages of the invention will become apparent from the specification, claims and drawings.

### SUMMARY OF THE INVENTION

A system for measuring ride characteristics of a vehicle, is presented that includes a module having a microprocessor, memory and instructions as well as a vibration sensor, a noise sensor, and a position sensor. The module is connected to a vehicle and when the vehicle is driven the module detects ride characteristics of the vehicle, such as vibration, direction, location, and noise levels. From this information the system establishes baseline ride characteristics, which is the optimal performance of the vehicle and compares the baseline ride characteristics to the actual or present ride characteristics. The system also establishes a threshold, which represents the worst acceptable ride characteristics. When the present ride characteristics exceed the threshold the system informs the user through a visual or audible alarm, a text or emailed message or through any other manner or means informing the user that it is time to repair or replace the vehicle.

### BRIEF DESCRIPTION OF THE DRAWINGS

FIG. 1 is an elevation view of a demonstrative schematic of the system for measuring ride characteristics of a vehicle; the view showing a vehicle having ride components including tires, wheels, shocks, suspension components, steering components, wheel bearings, a motor, motor mounts and a transmission; the view showing the vehicle having a module connected to the vehicle using a mount; the view showing the module having a microprocessor, memory, instructions, an application, sensors, an antenna, a display and a power source; the view showing the sensors including a vibration sensor, noise sensor, position sensor, accelerometer, temperature sensor, gyroscope and compass; the view showing the module wirelessly connected to an electronic network, the cloud, the internet, and a database as well as other electronic devices;

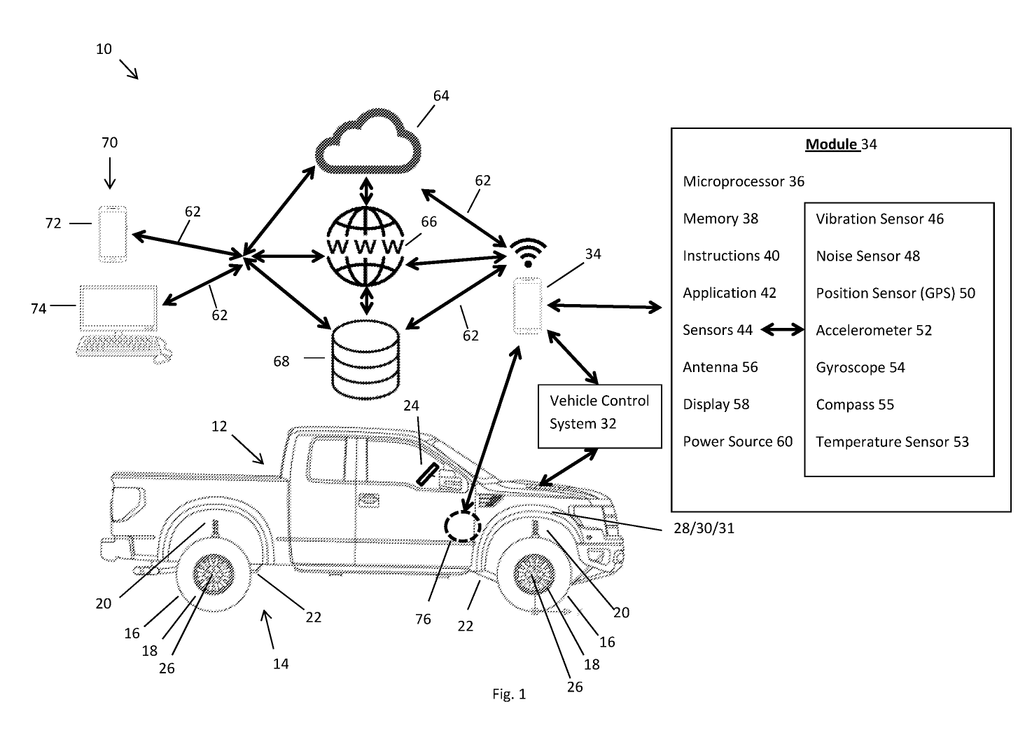

FIG. 2 is an elevation view of a graph showing an example of an analysis output from the system for measuring ride characteristics of a vehicle; the view showing time charted on the X-axis and ride characteristics or ride number charted on the Y-axis; the view showing a baseline ride characteristics, which represent the optimal performance; the view showing a threshold, which represents the worst acceptable performance; the view showing the present ride characteristics which represents the actual performance of the vehicles ride components.

### DETAILED DESCRIPTION OF THE PREFERRED EMBODIMENT

In the following detailed description, reference is made to the accompanying drawings which form a part hereof, and in which is shown by way of illustration specific embodiments in which the disclosure may be practiced. These embodiments are described in sufficient detail to enable those skilled in the art to practice what is disclosed, and it is to be understood that other embodiments may be utilized and that mechanical, procedural, and other changes may be made without departing from the spirit and scope of the disclosure. The following detailed description is, therefore, not to be taken in a limiting sense, and the scope of the disclosure is defined only by the appended claims, along with the full scope of equivalents to which such claims are entitled.

As used herein, the terminology such as vertical, horizontal, top, bottom, front, back, end, sides, left, right and the like, are referenced according to the views presented. It should be understood, however, that the terms are used only for purposes of description, and are not intended to be used as limitations. Accordingly, orientation of an object or a combination of objects may change without departing from the scope of the invention.

System:

With reference to the figures, a system for measuring the ride characteristics of a vehicle 10, or simply system 10, is presented. The system 10 is formed of any suitable size, shape and design and is configured to provide a user with an objective measure of the quality of the ride of a vehicle 12. In one arrangement, as is shown, system 10 includes the components of a vehicle 12 having ride components 14 that affect the quality of the ride including but not limited to tires 16, wheels 18, shocks 20, suspension components 22, steering components 24, wheel bearings 26, a motor 28, and motor mounts 30, among other components; the vehicle 12 also including a vehicle control system 32; the system 10 also including a module 34 having a microprocessor 36, memory 38, instructions 40, an application 42, and sensors 44, which may include a vibration sensor 46, a noise sensor 48, a position sensor 50, an accelerometer 52, a gyroscope 54 and a compass 55; the module 34 also including an antenna 56, a display 58, and connected to a power source 60; the module 34 electronically connected to an electronic network 62, such as the cloud 64 and/or the internet 66 and a database 68, system 10 also includes an electronic device 70, such as a mobile device 72 and/or a computer 74 wherein information from the system 10 is transmitted and/or displayed for further analysis and use; the system 10 also includes a mount 76 that is configured to mount the module 34 to the vehicle 12, among other components as are described herein.

Vehicle:

System 10 is configured to be used in association a vehicle 12. Vehicle 12 is formed of any suitable size, shape and design and is configured to travel between destinations while carrying people, cargo or a combination thereof. In one arrangement, as is shown, as one example, vehicle 12 is a conventional road vehicle as is shown in use with the system 10 which is in the form of a conventional pickup truck which serves as one of countless examples. Any other form of a vehicle is hereby contemplated for use with the system 10 such as any car, truck, semi, motorcycle, SUV, sports car, van, utility vehicle or any other form of a vehicle.

Vehicle 12 has a number of ride components 14 that affect the ride characteristics of vehicle 12. Ride components 14 are any components that affect the quality of the ride of vehicle 12. As these ride components 14 age or wear the ride characteristics of vehicle 12 deteriorate.

In one arrangement, as is shown, as one example, ride components 14 include the tires 16 of vehicle 12, the wheels 18 of vehicle 12, the shocks 20 of vehicle 12, the suspension components 22 of vehicle 12 such as bushings, bearings, torsion bars, or any other suspension components, steering components 24 of vehicle 12 such as the steering wheel, steering column, steering box, steering gears, power steering components, rack and pinion, tie rods, ball joints, universal joints, and any other steering related component, wheel bearings 26 of vehicle 12, and the motor 28 and associated motor mounts 30 and transmission 31 that connect motor 28 to vehicle 12, among any other component that affects the ride of vehicle 12.

Module 34 is connected to vehicle 12 and senses and tracks the quality of the ride of vehicle 12.

Module:

System 10 includes a module 34. Module 34 is formed of any suitable size, shape and design and is configured to detect and track ride characteristics of vehicle 12. Module 34 is any device that is capable of detecting and tracking ride characteristics of vehicle 12. In one arrangement, as is shown, is module 34 is a standalone component that is added to vehicle 12 as an accessory. In another arrangement, module 34 is formed as integral component with the vehicle 12.

In one arrangement, as is shown, module 34 includes at least one microprocessor 36, at least one memory 38, instructions 40, which are stored in memory 38, and an application 42 which runs on module 43, among other electronic components necessary for use and operation. Module 34 also includes sensors 44, an antenna 56 that facilitates wireless communications, a display 58 that displays information and facilitates the input of information, such as through a touch screen, and module 34 is electrically connected to a power source 60, which is either internal or external or both. In one arrangement, module 34 is also electrically connected to the vehicle control system 32 of vehicle 12.

Microprocessor 36 is formed of any suitable size, shape and design and is configured to receive information, process this information received according to instructions 40 stored in memory 38 and output desired results. In one arrangement, microprocessor 36 is a single self-contained unit. In another arrangement, microprocessor 36 is formed of two or more electrically connected components.

Memory 38 is formed of any suitable size, shape and design and is configured to receive information, store this information and provide this information for retrieval upon command by microprocessor 36 and other components of module 34. In one arrangement, memory 38 is a single self-contained unit. In another arrangement, memory 38 is formed of two or more electrically connected components. Memory 38 is any form of an electronic information storage device and may be formed of volatile memory and/or non-volatile memory and may include devices such as a hard drive, a flash drive, Random Access Memory (RAM) (including static random access memory (SRAM) and dynamic random access memory (DRAM)), flash memory, a flash drive, or any other form of memory.

In one arrangement microprocessor 36 and memory 38 are formed of a single combined component, such as an integrated chip. In another arrangement microprocessor 36 and memory 38 are formed of two separate components that are electrically connected to one another. In yet another arrangement, microprocessor 36 and memory 38 are formed of a plurality of electronic components that are electrically connected to one another and work in concert with one another to facilitate the functionality of system 10.

Instructions 40 are formed of any suitable configuration and information that facilitates the functionality of system 10 and module 34. Instructions 40 provide the operational guidelines for module 34 and more specifically microprocessor 36 and memory 38. In one arrangement, instructions 40 take the form of code, software, firmware, source code or any other information that instructs microprocessor 36 and memory 38 as to how to interpret the information received, how to process this information and what outputs to provide. In one arrangement, instructions 40 include or take the form of an application 42, app or mobile application. Application 42 is any form of software, code, computer code, firmware, or other programming that provides operational functionality of system 10 and module 34.

In one arrangement, as is shown, module 34 is formed of a conventional handheld device such as a smart phone, tablet, portable computer, portable computing device, laptop, or any other computing device or portable electronic device that is electronically connected to vehicle 12 either wirelessly or by wired communication or a combination of wireless and wired connection. This arrangement, where module 34 is a prepackaged and self-contained electronic component, is convenient and inexpensive as many commercially available portable electronic devices, such as smart phones, tablets, and the like are inexpensive and have a tremendous amount of capabilities and computing power. In addition, many portable hand held computing devices, such as smart phones include many of the components and capabilities described herein, including wireless connectivity, GPS capability, noise sensing capability, vibration sensing capability, direction sensing capability, acceleration sensing capability, motion sensing capability, and the like. In this arrangement, the portable handheld device that is module 34 is easily connected to and integrated into the vehicle control system 32 as an aftermarket accessory.

In an alternative arrangement, module 34 is integrated into the vehicle control system 32 as an integrated component of vehicle 12, when the vehicle 12 is manufactured. This arrangement provides the advantage that the vehicle manufacturer can select the optimum electronic components for the particular vehicle 12 and install them in the optimum position within the vehicle 12. This may reduce cost of the system 10 and improve the quality of the output.

Sensors:

Module 34 includes and/or is connected to a plurality of sensors 44. Sensors 44 are formed of any suitable size, shape and design and are configured to detect various ride characteristics 100 of vehicle 12. Any number of sensors 44 are connected to, incorporated within, or used in association with module 34. In one arrangement, as is shown, sensors 44 include a vibration sensor 46, noise sensor 48, position sensor 50, such as GPS or the like, an accelerometer 52, a gyroscope 54, a compass 55, a temperature sensor 53 and any other sensor that provides information regarding the quality of the ride of vehicle 12.

In the arrangement wherein a vibration sensor 46 is used in association with the system 10, vibration sensor 46 is formed of any suitable size, shape and design and is either incorporated within module 34 or is attached as a separate component that is external to and connected to module 34. Vibration sensor 46 senses the vibration within vehicle 12. In one arrangement, vibration sensor 46 is capable of sensing and detecting the displacement, velocity and acceleration associated with the vibrations the vehicle 12 experiences. In one arrangement, vibration sensor 46 is capable of sensing vibrations within any vibration range and frequency range and reporting the range and frequency of the vibration to microprocessor 36. In one arrangement, vibration sensor 46 is capable of detecting the directionality of vibrations in the X, Y and Z directions (X being forward to back, Y being left to right, and Z being up and down). Vibration sensor 46 may be analog or digital. The information detected by vibration sensor 46 is transmitted to microprocessor 36, analyzed, distilled and/or stored in memory 38 and/or transmitted through electronic network 62 to the cloud 64, internet 66 and/or database 68 for storage and/or further analysis as a component to assist with determining the ride characteristics of vehicle 12. The greater the vibration the worse the ride characteristics.

One component of some vibration analyses is sensing acceleration. As such, in some arrangements, an accelerometer serves as a vibration sensor. In other arrangements, a separate vibration sensor and an accelerometer are separate components. In the arrangement wherein a vibration sensor 46 and a separate accelerometer 52 are used, accelerometer 52 is formed of any suitable size, shape and design and is either incorporated within module 34 or is attached as a separate component that is external to and connected to module 34. Accelerometer 52 senses acceleration or proper acceleration being the acceleration (or rate of change of velocity) of a body in its own instantaneous rest frame. In one arrangement, accelerometer 52 is an electromechanical device that measures acceleration forces, which may be static, such as the constant force of gravity, or they may be dynamic such as that caused by moving or vibrating the accelerometer 52. Accelerometer 52 may be sensor that measures the dynamic acceleration of a physical device as a voltage. Accelerometer 52 may be analog or digital and may be a one-axis, a two-axis or three-axis accelerometer (for three dimensional positioning) or two two-axis accelerometers mounted at ninety degrees to one another, or three one-dimensional accelerometers mounted at ninety degrees to one another, or any combination thereof. In one arrangement, accelerometer 52 uses the piezoelectric effect, meaning it contains microscopic crystal structures that get stressed by accelerative forces, which causes a voltage to be generated which is interpreted as acceleration. In another arrangement, accelerometer 52 senses changes in capacitance between two proximate microstructures, which when they are moved relative to one another capacitance changes, which is interpreted as acceleration. However any other form of an accelerometer is hereby contemplated for use. The information detected by accelerometer 52 is transmitted to microprocessor 36, analyzed, distilled and/or stored in memory 38 and/or transmitted through electronic network 62 to the cloud 64, internet 66 and/or database 68 for storage and/or further analysis as a component to assist with determining the ride characteristics of vehicle 12.

In one arrangement, vibration sensor 46 and/or accelerometer 52 may take the form of a seismometer or seismograph which tracks vibration and/or motion of one object relative to another.

In the arrangement wherein a gyroscope 54 is used in association with the system 10, gyroscope 54 is formed of any suitable size, shape and design and is either incorporated within module 34 or is attached as a separate component that is external to and connected to module 34. Gyroscope 54 senses and/or measures the orientation and/or angular velocity of vehicle 12 and operates based on the principles of conversation of angular momentum. Gyroscope 54 may be a mechanical gyroscope, or an electronic gyroscope. When a mechanical gyroscope 54 is used it includes a gyroscope frame, a gimbal, a rotor and a spin axis that allows freedom of rotation in all three axes allowing the rotor to maintain its spin axis direction regardless of the orientation of the outer frame. When an electronic gyroscope 54 is used it may take one of many forms. One form of an electronic gyroscope is what is known as a microelectromechanical systems (MEMS) gyroscope which is a miniaturized gyroscope found in electronic devices which takes the idea of the Foucault pendulum and uses a vibrating element. When a MEMS gyroscope is rotated, a small resonating mass is shifted as the angular velocity changes. This movement is converted into very low-current electrical signals that can be amplified and read by a host microcontroller. Another form of an electronic gyroscope is what is known as a hemispherical resonator gyroscope (HRG), also called wine-glass gyroscope or mushroom gyro, operates using a thin solid-state hemispherical shell, anchored by a thick stem. This shell is driven to a flexural resonance by electrostatic forces generated by electrodes which are deposited directly onto separate fused-quartz structures that surround the shell. Gyroscopic effect is obtained from the inertial property of the flexural standing waves. Another form of an electronic gyroscope is what is known as a vibrating structure gyroscope (VSG), also called a Coriolis vibratory gyroscope (CVG), which uses a resonator made of different metallic alloys. It takes a position between the low-accuracy, low-cost MEMS gyroscope and the higher-accuracy and higher-cost fiber optic gyroscope. Accuracy parameters are increased by using low-intrinsic damping materials, resonator vacuumization, and digital electronics to reduce temperature dependent drift and instability of control signals. Another form of an electronic gyroscope is what is known as a dynamically tuned gyroscope (DTG) which is a rotor suspended by a universal joint with flexure pivots. The flexure spring stiffness is independent of spin rate. However, the dynamic inertia (from the gyroscopic reaction effect) from the gimbal provides negative spring stiffness proportional to the square of the spin speed. Therefore, at a particular speed, called the tuning speed, the two moments cancel each other, freeing the rotor from torque, a necessary condition for an ideal gyroscope. Another form of an electronic gyroscope is what is known as a ring laser gyroscope which relies on the Sagnac effect to measure rotation by measuring the shifting interference pattern of a beam split into two halves, as the two halves move around the ring in opposite directions. Another form of an electronic gyroscope is what is known as a fiber optic gyroscope which uses the interference of light to detect mechanical rotation. The two halves of the split beam travel in opposite directions in a coil of fiber optic cable and makes use of the Sagnac effect. Another form of an electronic gyroscope is what is known as a London moment gyroscope which relies on the quantum-mechanical phenomenon, whereby a spinning superconductor generates a magnetic field whose axis lines up exactly with the spin axis of the gyroscopic rotor. A magnetometer determines the orientation of the generated field, which is interpolated to determine the axis of rotation. Any other form of a gyroscope or gyrostat is hereby contemplated for use as gyroscope 54. The information detected by gyroscope 54 is transmitted to microprocessor 36, analyzed, distilled and/or stored in memory 38 and/or transmitted through electronic network 62 to the cloud 64, internet 66 and/or database 68 for storage and/or further analysis as a component to assist with determining the ride characteristics of vehicle 12.

In the arrangement wherein a compass 55 is used in association with the system 10, compass 55 is formed of any suitable size, shape and design and is either incorporated within module 34 or is attached as a separate component that is external to and connected to module 34. Compass 55 is any device that senses the relative direction and/or direction of travel of vehicle 12. Compass 55 may be formed of a magnetic compass, a gyrocompass, a solid state compass, a GPS compass which uses GPS information to determine direction, or any other form of a compass. In one arrangement, compass 55 is an electronic compass that uses Hall Effect sensors and a magnetic concentrator formed of a disk of high permeability material to detect magnetic fields from which direction is determined. The information detected by compass 55 is transmitted to microprocessor 36, analyzed, distilled and/or stored in memory 38 and/or transmitted through electronic network 62 to the cloud 64, internet 66 and/or database 68 for storage and/or further analysis as a component to assist with determining the ride characteristics of vehicle 12.

In the arrangement wherein a position sensor 50 is used in association with the system 10, position sensor 50 is formed of any suitable size, shape and design and is either incorporated within module 34 or is attached as a separate component that is external to and connected to module 34. Position sensor 50 is any device that senses the position and/or direction of travel of vehicle 12. In one arrangement, position sensor 50 is a Global Positioning System (GPS) sensor which is a radio-navigation system that provides geolocation and time information to a GPS receiver anywhere on or near the Earth where there is an unobstructed line of sight to three or more GPS satellites using trilateration. In another arrangement, position sensor 50 is what is known as an Assisted GPS system (AGPS) which uses GPS information in conjunction with position information from cell phone towers and Wi-Fi networks to calculate position. Alternatively, in one arrangement, position sensor 50 uses only signals from terrestrial points, such as cell phone towers and Wi-Fi networks are used to calculate position. The information detected by position sensor 50 is transmitted to microprocessor 36, analyzed, distilled and/or stored in memory 38 and/or transmitted through electronic network 62 to the cloud 64, internet 66 and/or database 68 for storage and/or further analysis as a component to assist with determining the ride characteristics of vehicle 12.

In the arrangement wherein a noise sensor 48 is used in association with the system 10, noise sensor 48 is formed of any suitable size, shape and design and is either incorporated within module 34 or is attached as a separate component that is external to and connected to module 34. Noise sensor 48 is any device that senses noises during operation of vehicle 12. Noise sensor 48 may detect the volume, pitch, frequency, cadence or any other information regarding the noise within vehicle 12. In one arrangement, noise sensor 48 is a microphone, or a plurality of microphones. The information detected by noise sensor 48 is transmitted to microprocessor 36, analyzed, distilled and/or stored in memory 38 and/or transmitted through electronic network 62 to the cloud 64, internet 66 and/or database 68 for storage and/or further analysis as a component to assist with determining the ride characteristics of vehicle 12.

In one arrangement, a temperature sensor 53 is also used in association with the system 10. Temperature sensor 53 is formed of any suitable size, shape and design and is either incorporated within module 34 or is attached as a separate component that is external to and connected to module 34. Temperature sensor 53 is any device that senses temperature during operation of vehicle 12. Temperature sensor 53 may directly detect temperature, such as a thermometer. Alternatively, temperature sensor 53 may provide temperature through connectivity to a temperature providing device, system or service, such as the national weather service, the internet or the like. The information detected by temperature sensor 53 is transmitted to microprocessor 36, analyzed, distilled and/or stored in memory 38 and/or transmitted through electronic network 62 to the cloud 64, internet 66 and/or database 68 for storage and/or further analysis as a component to assist with determining the ride characteristics of vehicle 12.

Combination of Sensor Information:

Sensors 44 include any other form of a sensor. The information from multiple sensors 44 is combined in a manner to provide insight into the ride characteristics of vehicle 12. That is, information from one sensor 44 may only provide partial information about the ride characteristics of the vehicle 12, whereas when the information is combined from multiple sensors 44 deeper insight is provided regarding the true ride characteristics.

As an example, position information from position sensor 50 when combined with vibration information from vibration sensor 46 may be able to isolate variables such as road variables from the data. That is, when it is known that the vehicle 12 is traveling on the same road, the data should be the same with the only variable being deterioration in the ride components 14 of the vehicle. As such, the system 10 combines ride information from similar portions of the road and thereby isolating the road condition variables.

As another example, temperature information from temperature sensor 53 is combined with the other information from other sensors 44. It is well known that vehicle 12 may ride looser or smoother in July when the temperature is hot as compared to January when the temperature is cold. As such, the system 10 combines ride information when the temperature is similar thereby isolating the effects of temperature.

As another example, speed or acceleration information from accelerometer 52 and/or position sensor 50 is combined with the other information from other sensors 44. The ride characteristics of vehicle 12 change as the acceleration or speed of vehicle 12 changes. Combining the speed or acceleration information from accelerometer 52 and/or position sensor 50 allows ride information from similar accelerations or similar speeds to be compared. As such, the system 10 isolates the effect of speed and/or acceleration as a variable affecting the ride characteristics.

Any other combination of information or isolation of information is hereby contemplated for use to remove or reduce the effect of variables on the information gathered by sensors 44 to determine the performance characteristics of the ride components 14 of vehicle 12. The system 10 also applies artificial intelligence and machine learning to extract further insights into the data from sensors 44.

Antenna:

System 10 and/or module 34 include an antenna 56. Antenna 56 is formed of any suitable size, shape and design and is configured to facilitate wireless communication from and/or to system 10 and/or module 34 and external components such as electronic network 62, cloud 64, internet 66, database 68 and/or electronic devices such as mobile device 72 and/or computer 74. Antenna 56 is any device which serves as the interface between radio waves propagating through space and electric currents moving in metal conductors, used with a transmitter or receiver. In transmission, a radio transmitter and/or microprocessor 36 supplies an electric current to the terminals of antenna 56, and the antenna 56 radiates the energy from the current as electromagnetic waves (radio waves). In reception, the antenna 56 intercepts some of the power of an electromagnetic wave in order to produce an electric current at its terminals, that is applied to a receiver to be amplified and later used by microprocessor 36. Antenna 56 facilitates one way and two way communication and data transfer.

Display:

In one arrangement, system 10 and/or module 34 includes a display 58. Display 58 is any device that facilitates the display of information associated with system 10, application 42 or any other component of the system 10 such as a screen, LCD screen, touch screen, or any other visual display. In one arrangement, display 58 also serves as an input, such as through the use of a touch screen display that facilitates the manipulation of the system and entry of information. Alternatively, a separate input is attached to system 10 and/or module 34 such as a keyboard, mouse and/or the like.

In the arrangement, wherein module 34 is a self-contained component connected to vehicle 12 such as a smart phone, tablet, or the like, display 58 is incorporated within this self-contained component. In the arrangement, wherein module 34 is incorporated within vehicle 12, display 58 may be part of the vehicle control system 32 or navigation system or the like, such as an in-dash display.

Power Source:

Power source 60 is formed of any suitable size, shape and design and is configured to provide power to system 10 and/or module 34. In one arrangement, wherein module 34 is a self-contained component connected to vehicle 12, power source 60 is a self-contained battery. In one arrangement, wherein module 34 is integral or incorporated within vehicle 12, power source 60 may be part of the vehicle control system 32 and/or vehicle 12. In yet another arrangement, power source 60 is a combination of a self-contained battery as well as being connected to the power source of vehicle 12.

Electronic Network, Cloud, Internet, Database and Electronic Device:

In one arrangement, system 10 and/or module 34 is connected to and communicates with external electronic components such as electronic network 62, cloud 64, internet 66 database 68 and/or electronic device 70 such as mobile device 72 and/or computer 74.

In one arrangement, system 10 and/or module 34 communicates through antenna 56 over an electronic network 62. Electronic network 62 may be any electronic network that includes wireless communication capabilities such as a cellular network wherein system 10 and/or module 34 communicates with cellular towers; a satellite network wherein system 10 and/or module 34 communicates with satellites; a Personal Area Network (PAN) or a Local Area Network (LAN) or a Metropolitan Area Network (MAN) or a Wide Area Network (WAN), a mesh network or any other network wherein system 10 and/or module 34 communicates with access points, such as routers, gateways, repeaters or the like, or any combination thereof. System 10 and/or module 34 is capable of communicating using any one or a combination of wireless communication protocols such as cellular communication, Wi-Fi, Z-Wave, ZigBee, Bluetooth, Bluetooth LTE, or any other communications protocol and/or frequency or wavelength. Electronic network 62 serves as the intermediary or serves as a data-transfer system between system 10 and/or module 34 on one side and cloud 64, internet 66 database 68 and/or electronic device 70 such as mobile device 72 and/or computer 74 on the other side.

In one arrangement, system 10 and/or module 34 communicates over electronic network 62 with the cloud 64 and/or internet 66 and/or database 68. The internet 66 is a global system of interconnected computer networks that use the Internet protocol suite (TCP/IP) to link devices worldwide and consists of private, public, academic, business, and government networks of local to global scope, linked by a broad array of electronic, wireless, and optical networking technologies. The cloud 64 is a physical infrastructure of interconnected servers that facilitate various functionality such as data storage, data analysis, running of applications and the delivery of various computing services. The cloud 64 facilitates global access to information stored and/or produced by dedicated computers or serves via access through electronic network 62 and/or the internet 66. Database 68 is any remote electronic data storage, data analysis and/or computing device that can be connected to through electronic network 62 and/or the internet 66 and/or the cloud 66 and facilitates software-as-a-service and computing-as-a-service functionality. In one arrangement database 68 facilitates the computation of much of the data and information received from system 10 and/or module 34 and in this way database 68 may serve as data storage as well as a central processing or central computing system. This arrangement facilitates the hosting and utilization of a web-based application in association with the system 10.

Utilization of electronic network 62 and/or the internet 66 and/or the cloud 66 and/or database 68 allows for placing capabilities remote from vehicle 12. This allows for the remote storage and manipulation of data and information, this allows for improved data security, this allows for less sophisticated and expensive components to be used in vehicle 12, among a host of other benefits.

When using a remote database 68 an/or the cloud 64 in one arrangement, electronic devices 70 such as a user's mobile device 72, such as a smart phone, tablet or the like, and/or a user's computer 74 or any other electronic device 70 may be used to access the information generated by system 10 and module 34 as well as the consolidated results of the ride characteristics 100 through remote connection through the internet 66 and/or electronic network 62.

Mount:

In one arrangement, system 10 includes a mount 76. Mount 76 is formed of any suitable size, shape and design and is configured to mount module 34 to vehicle 12. In one arrangement, it is important that module 34 and/or sensors 44 are held to the vehicle 12 in a consistent manner so as to ensure the readings of sensors 44 are consistent from ride-to-ride. As such, in one arrangement, mount 76 facilitates connection of module 34 and/or sensors 44 to vehicle 12. In the arrangement, wherein module 76 is formed of a conventional handheld device such as a smart phone, tablet, portable computer, portable computing device, laptop, or any other computing device or portable electronic mount 76 serves as a bracket or other mounting member that physically connects module 34 to the vehicle 12 in a rather rigid manner so that when the vehicle 12 experiences vibrations, those vibrations are transferred to module 34; when vehicle 12 experiences acceleration, that acceleration is transferred to module 34; when vehicle 12 experiences body roll or list, that body roll or list is transferred to module 34, and so on. In one arrangement, mount 76 rigidly connects to a frame member of vehicle 12 either directly or through connection to intermediary devices.

In one arrangement, when the system 10 runs on a user's hand held device, such as their smart phone or other connected device, it is desirable to allow the user to easily use their hand held device and move it from vehicle 12 to vehicle 12. In one arrangement, mount 76 is a suction-cup system that facilitates connection to the windshield of the vehicle 12 or other surface. This arrangement facilitates quick and easy installation while also allowing for quick removal. This arrangement also facilitates consistent transfer of vibrations from the vehicle to the handheld device for sensing purposes. In another arrangement, mount 76 is a container or holder that allows the handheld device to be quickly and easily inserted into an opening that holds the handheld device in place. This arrangement also facilitates consistent transfer of vibrations from the vehicle to the handheld device for sensing purposes. This arrangement also allows the user to remove the handheld device in a quick and easy manner upon departing the vehicle. In another arrangement, no specific mount 76 is used and instead the handheld device interprets the information needed simply by being within vehicle 12 and the software interprets the needed information to determine the quality of the ride from noise in the background due to not being mounted in a consistent manner. Any other manner or method of attaching module 34 to vehicle 12 is hereby contemplated for use.

In Operation:

In the arrangement, wherein module 34 is formed of a conventional handheld device such as a smart phone, tablet, portable computer, portable computing device, laptop, or any other computing device or portable electronic, module 34 is installed into vehicle 12 by mounting module 34 to vehicle 12 using mount 76. In one arrangement, mount 76 is screwed, bolted or otherwise attached to the body or frame or other component of vehicle 12 and module 34 is installed therein. In one arrangement, module 34 is also electrically connected to vehicle control system 32 of vehicle 12 that facilitates power and/or information transfer between vehicle 12 and module 34.

Application 42 is also installed onto module 34 through wireless communication over electronic network 62 and connection to internet 66 and/or the cloud 66 and/or database 68. Once application 42 is installed on module 34, the application runs on module 34.

Once installed and running, as vehicle 12 is operated sensors 44 sense parameters such as vibration, noise level, temperature, body roll, direction, position, speed, acceleration and any other parameter. This information is interpreted by microprocessor 36 according to instructions 40 stored in memory 38 and this information, or distilled information is stored in memory 38.

In one arrangement, wireless connectivity is established on a continuous basis or on an intermittent basis (such as on an as-needed or when-available basis) between module 34 on one side and the cloud 64, the internet 66 and/or database 68 on the other side over electronic network 62. When this connection is made, data and information transfer is made between module and the cloud 64, the internet 66 and/or database 68.

In one arrangement, the information detected by module 34 through sensors 34 is monitored and analyzed to determine ride characteristics 100 of vehicle 12. In one arrangement, ride characteristics 100 is presented in a numerical form and is an objective measure of the quality of the ride of vehicle 12. In one arrangement, ride characteristics 100 is presented as a single number to represent the overall quality of the ride of vehicle 12. In another arrangement, ride characteristics 100 is presented as a plurality of numbers, each representing a different component of the quality of the ride of vehicle 12. In one arrangement, this is represented as an X-number, which represents forward to back motion or horizontal motion, a Y-number, which represents side motion or lateral motion, and/or a Z-number, which represents vertical motion. Any other number of components are hereby contemplated for use to describe ride characteristics 100, from one value which describes the overall ride quality, to any amount of numbers, where each describes a separate component of ride quality.

In one arrangement, to determine the quality of the ride of vehicle 12, module 34 establishes baseline ride characteristics 102. Baseline ride characteristics 102 represent optimal or desired or best performance of ride components 14 and/or the quality of the ride of vehicle 12. In one arrangement, baseline ride characteristics 102 are established through the interpretation of ride characteristics when the system 10 is initially installed into vehicle 12, such as when the vehicle 12 is brand new. In another arrangement, baseline ride characteristics 100 are established knowns or standards provided for a particular vehicle or model of vehicle. In another arrangement, baseline ride characteristics 102 are a standard or known for all vehicles. Alternatively, baseline ride characteristics 102 are established by any other manner, method or means.

In one arrangement, once baseline ride characteristics 100 are established, the information detected by module 34 through sensors 34 when vehicle 12 is operated is analyzed to determine present ride characteristics 104. Present ride characteristics 102 represent the present performance of ride components 14 and/or the present quality of the ride of vehicle 12. Present ride characteristics 104 are calculated from actual use of vehicle 12. Present ride characteristics 104 may be referred to as a ride number 108.

In one arrangement, present ride characteristics 104, which represent the present or actual quality of the ride of vehicle 12 are compared to baseline ride characteristics 102, which represent the optimal or desired or best performance of ride components 14 and/or the quality of the ride of vehicle 12. Through this comparison, the difference between baseline ride characteristics 102 and present ride characteristic 104 represents the difference between the present performance and the desired or optimal performance. This difference represents the amount of wear or deterioration of ride components 14 of vehicle 12. This difference alone may provide valuable insight into whether repairs to the ride components 14 and/or replacement of vehicle 12 is warranted.

In one arrangement, a threshold 106 is established. Threshold 106 represents the greatest acceptable amount of deterioration in the performance of ride components 14 of vehicle 12. Threshold 106 may be established by a known or standard for the particular vehicle or for all vehicles. Alternatively, threshold 106 may be an interpreted or calculated value, such as a 25% reduction from the baseline ride characteristics 102. Alternatively, threshold 106 is established by any other manner, method or means. Once the present ride characteristics 104 exceed threshold 106 the user is alerted that it is time for repairs to ride components 14, such as replacing shocks 20, or replacement of vehicle 12 is warranted.

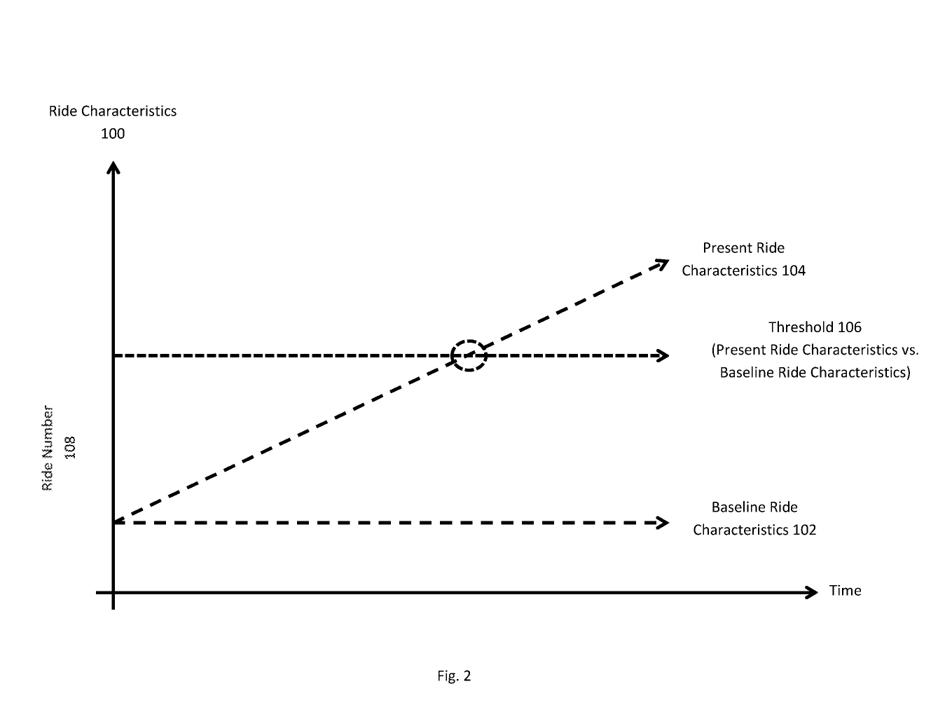

With reference to FIG. 2, system 10 graphs the baseline ride characteristics 102, present ride characteristics 104 and threshold 106 are graphed with the X-axis representing time and the Y-axis representing ride characteristics 100, or the quality of the ride. This graph which is generated by system 10, such as by the module 34 and displayed on display 58, shows a graphical representation of where the present ride characteristics 104, or present ride quality or ride number 108 is in comparison to the baseline ride characteristics 102, or optimum performance, as well as in comparison to the threshold 106 which represents the worst acceptable performance. This information and graph can also be used to extrapolate future events or graph future predicted information, such as how much longer it will be before the threshold 106 is exceeded and repairs are needed. With this information, the user can visually see where present performance is compared to optimum performance and with this information the user can make informed decisions regarding repairs or replacement.

Other Uses:

The system 10 presented herein is used, primarily, to determine the present ride characteristics 104 of vehicle 12 as well as to use this information to determine when repairs or replacement of vehicle 12 is required. However, the system 10 provides countless other benefits as the system 10 provides access to information that was never before accessible. This new information can be used for countless purposes. As one example, this information can be used by car manufacturers to determine how well their vehicles 12 and associated ride components 14 are performing. As another example, this information can be used by rating agencies to determine the quality and ranking of various vehicles for safety, ride, quality, durability, longevity, and other categories. As another example, with multiple vehicles 12 traveling over roads using system 10, state and federal agencies, such as the Department of Transportation can use the information, such as ride number 108 and position or location information gathered by systems 10 to determine when to repair or replace road surfaces.

Multiple Vehicles:

It is desirable to facilitate use of system 10 across multiple vehicles. To facilitate this, in one arrangement, the system 10 syncs or connects with the electronic control system 32 and determines what vehicle the module 34 is presently in such as through Bluetooth, Wi-Fi or by any other method of connecting. Once the module 34 determines what vehicle 12 it is in, module 34 accumulates data for that specific vehicle 12. In this way, the module 34 can track ride quality data for each vehicle 12 the module 34 rides in. In this way, the module 34 seamlessly and without user interaction self-associates what vehicle the ride data should be attributed to for calculation of a ride number 108 without the need to enter information into the module 34 and without the need to plug the module into the vehicle 12. This allows for ultimate portability and seamless operation.

From the above discussion and the accompanying drawings and claims it will be appreciated that the system and method for measuring ride characteristics of a vehicle presented herein meets all of its stated objectives. That is, the system and method for measuring ride characteristics of a vehicle presented herein: improves upon the state of the art; provides a baseline or optimal level of ride characteristics; provides an objective measure of ride characteristics; informs a user when ride characteristics of a vehicle have deteriorated to a point where repairs or changes are needed; informs a user when ride characteristics of a vehicle are still within an acceptable range and as such repairs or changes are not needed; provides statistical information regarding the ride characteristics of a vehicle; provides graphical information regarding the ride characteristics of a vehicle; is relatively inexpensive; is easy to use; improves safety; detects subtle changes in a vehicle's ride characteristics over; can be used with practically any vehicle; that detects vibration; that detects noise levels; that detects body roll; that provides a ride score; that can inform a user what changes or repairs are needed, such as tire changes, wheel bearing changes, shock absorber changes, or the like; that provides a vertical baseline and a horizontal baseline; that is; that utilizes existing technology; that saves money; that eliminates waste; that improves user satisfaction; that is easy to implement; that is easy to; that provides value, utility and novelty; that can be used in multiple vehicles by moving the system from vehicle to vehicle; that automatically determines what vehicle the system is riding in through wireless connection to the vehicle so as to accumulate ride data across multiple vehicles, among countless other improvements and advantages.

It will be appreciated by those skilled in the art that other various modifications could be made to the device, method or system without parting from the spirit and scope of this disclosure. All such modifications and changes fall within the scope of the claims and are intended to be covered thereby. It should be understood that the examples and embodiments described herein are for illustrative purposes only and that various modifications or changes in light thereof will be suggested to persons skilled in the art and are to be included within the spirit and purview of this application.

What is claimed:

1. A system for measuring ride characteristics of a vehicle, the system comprising:
a module;
the module having a microprocessor, memory and instructions;
the module having a vibration sensor, a noise sensor, and a position sensor;
the module connected to a vehicle;
wherein when the vehicle is driven, the module detects ride characteristics of the vehicle;
wherein the module establishes baseline ride characteristics;
wherein the module tracks present ride characteristics, compares the present ride characteristics to the baseline ride characteristics and informs a user when the present ride characteristics exceed a predetermined threshold from the baseline ride characteristics.

2. The system of claim 1 wherein the module is a hand held device.

3. The system of claim 1 wherein the module is a computer.

4. The system of claim 1 wherein the module is a smart phone.

5. The system of claim 1 wherein the module runs an application.

6. The system of claim 1 wherein the module includes a display.

7. The system of claim 1 wherein the module is mounted to the vehicle using a mount.

8. The system of claim 1 wherein the module provides a graphical representation of the baseline ride characteristics compared to the present ride characteristics.

9. The system of claim 1 wherein the position sensor is a Global Positioning System (GPS) sensor.

10. The system of claim 1 wherein module combines information the module receives from sensors to provide a ride number that provides a numerical representation of the quality of the ride of the vehicle.

11. The system of claim 1 wherein the module is electrically connected to a vehicle control system of the vehicle.

12. A method for measuring ride characteristics of a vehicle, the steps comprising:
providing a vehicle;
attaching a module to the vehicle, the module having a microprocessor, memory, instructions and running an application;
sensing ride characteristics of the vehicle by the module using a vibration sensor, a noise sensor and a position sensor when the vehicle is operated;
establishing baseline ride characteristics of the vehicle by the module;
tracking present ride characteristics of the vehicle by the module;
determining a ride number by the module that is a numerical representation of the quality of the ride of the vehicle based on a comparison of the present ride characteristics to the baseline ride characteristics.

13. The method of claim 12 further comprising the step of informing a user when the present ride characteristics exceed a predetermined threshold when compared to the baseline ride characteristics.

14. The method of claim 12 further comprising the step of providing a graphical representation of the present ride characteristics compared to the baseline ride characteristics.

15. The method of claim 12 further comprising the step of mounting the module to the vehicle using a mount.

16. The method of claim 12 wherein the module is a hand held device.

17. The method of claim 12 wherein the module is a smart phone.

18. The method of claim 12 wherein the module includes a display.

19. The method of claim 12 wherein the position sensor is a Global Positioning System (GPS) sensor.

20. The method of claim 12 further comprising the step of electrically connecting the module to a vehicle control system of the vehicle.
